(19) United States
(12) Patent Application Publication
(10) Pub. No.: US 2004/0040146 A1
(43) Pub. Date: Mar. 4, 2004

(54) Heat sink manufacturing apparatus

(75) Inventor: Chung-Chuen Sun, Ping Zhen City (TW)

Correspondence Address: TROXELL LAW OFFICE PLLC, SUITE 1404, 5205 LEESBURG PIKE, FALLS CHURCH, VA, 22041, US

(73) Assignee: Fan Zhen Co., Ltd.

(21) Appl. No.: 10/229,142

(22) Filed: Aug. 28, 2002

(51) Int. Cl. B23P 15/26

(52) U.S. Cl. 29/727

(57) ABSTRACT

The heat sink manufacturing apparatus comprises: a working machine, a set of linkage equipment and a feeding mechanism; wherein a working zone of the working machine has therein the feeding mechanism, a power arm of the working machine drives an elastically extending and contracting knife set; a material block fixed on the feeding mechanism which progresses for a predetermined distance is cut in a bevel way by the knife set; the process of cutting is repeated till the feeding mechanism reaches its end to contact a contact switch to stop the operation of the machine.

### BACKGROUND OF THE INVENTION

1. Field of the Invention

The present invention is related to a heat sink manufacturing apparatus, and especially related to a manufacturing apparatus in which a working machine, a set of linkage equipment and a feeding mechanism cooperate to form the manufacturing apparatus that can increase production rate and lower cost of production; the manufacturing apparatus suits particularly manufacturing of a heat sink or the like.

2. Description of the Prior Art

By virtue that science and technology as well as industries have been highly developed; the rate of inventing of various electric appliances is raised relatively. To these electric appliances, the problem of heat sinking is quite important in maintaining normal operation of the electric appliances; especially by fast progressing of modern computers, working speed of CPU's gets faster and faster from day to day, and high temperature results accordingly, it needs heat sinks of high efficiency with fans for scattering heat, otherwise, the CPU's will be burned.

Speak about a conventional heat sink often seen, it is made by extruding of aluminum; the heat sink made by extruding of aluminum has fins with quite large thickness, and the space between every two fins is unable to be reduced. Thereby, number of fins that can be formed in every unit area is limited, and heat sinking area can not be effectively increased. A single fin has limited heat sinking effect; the only way to increase the heat sinking area is to make the heat sink relatively large, but this does not meet the requirement of the above mentioned CPU's of high speeds.

To eliminate the problem that the volume of a heat sink is large but the heat sinking effect of the heat sink is not good, a new fashioned heat sink has been made by using an automation CNC working machine. Such a working machine has a knife set fixed and has the fed material pushed forwards in sequence; the material block is cut in a bevel way to get fins, the thickness of cutting each time is very small, this can reduce the space between every two fins to largely reduce the volume of the heat sink; however, the working machine is expensive at a price of about 4,000 thousands New Taiwan Dollar, while its speed of manufacturing is slow, this is the primary defect thereof.

And in another conventional heat sink often seen, it comprises a lot of heat sinking fins and a positioning rod extending in the hollow areas on the surfaces of the fins, a deformed portion on the positioning rod tightly clamps the two sides of the hollow area of each heat sinking fin, so that the positioning rod can be easily and integrally connected with the heat sinking fins separated from one another, and the heat sinking fins are concentrated to get extreme high density.

Although the structure of the above stated heat sink can reduce the space between every two fins, it needs another process for extending and connecting of the fins and the positioning rod to form the heat sink for use, the heat sink can not be integrally formed and thereby is still undesired.

Therefore, the inventor of the present invention worked for improving heat sinks to get rid of the defects resided in the conventional structures, and thereby provided a heat sink manufacturing apparatus using a conventional working machine in cooperating with a set of linkage equipment and a feeding mechanism to integrally form the heat sink from a material block; the heat sink manufacturing apparatus for acquiring the heat sink structure can be obtained without additional process of combination, the apparatus can be conveniently used by customers, and this is the motive of the present invention.

### SUMMARY OF THE INVENTION

The primary object of the present invention is to provide a heat sink manufacturing apparatus in which a working machine, a set of linkage equipment and a feeding mechanism cooperate to integrally form a heat sink.

The secondary object of the present invention is to provide a heat sink manufacturing apparatus that can increase production rate and lower cost of production.

To get the object, the present invention mainly is comprised of: a working machine, a set of linkage equipment and a feeding mechanism, wherein the working machine is provided in a working zone thereon with the feeding mechanism and a power arm to drive an elastically extending and contracting knife set progressing in a bevel way. The power arm is provided laterally thereof with a fin fixing rod; the linkage equipment includes a cam on a follower axle of the working machine to move a linked-up rod which is provided on the bottom thereof with a linked-up gear, a rod connected with the linked-up gear connects and rotates a reducing gear; the feeding mechanism is provided thereon with a clamping seat, the clamping seat is provided on the end thereof with a contact switch and is moved by an internal bolt for forwarding and retracting. The bolt is provided on one end thereof with a transmission gear engaged with the reducing gear of the linkage equipment, and is provided on the other end thereof with a motor. By driving the elastically extending and contracting knife set by the power arm, the material block clamped on the feeding mechanism can be cut in a bevel way, and the power arm synchronically links up the feeding mechanism through the linkage equipment to make the material on the feeding mechanism advance for a same distance each time. The process of cutting in a bevel way of the knife set is repeatedly executed until the feeding mechanism reaches an end and touches a switch to stop motion.

The present invention will be apparent in its novelty and features after reading the detailed description of the preferred embodiments thereof in reference to the accompanying drawings.

### BRIEF DESCRIPTION OF THE DRAWINGS

FIG. 1 is a plane view of an embodiment of the present invention;

FIG. 2 is a perspective view of part of the embodiment of the present invention;

FIGS. 3-4 are schematic views showing the actions of parts of the embodiment of the present invention;

FIG. 4a is an enlarged schematic view showing operation of the knife set of the present invention;

FIG. 5 is a plane schematic view showing completion of operation of the embodiment of the present invention;

FIG. 6 is a perspective view of an article made by the present invention;

FIG. 7 is a perspective view of another embodiment of the present invention;

FIG. 8 is a schematic view showing the action of part of the embodiment of FIG. 7.

### DETAILED DESCRIPTION OF THE PREFERRED EMBODIMENT

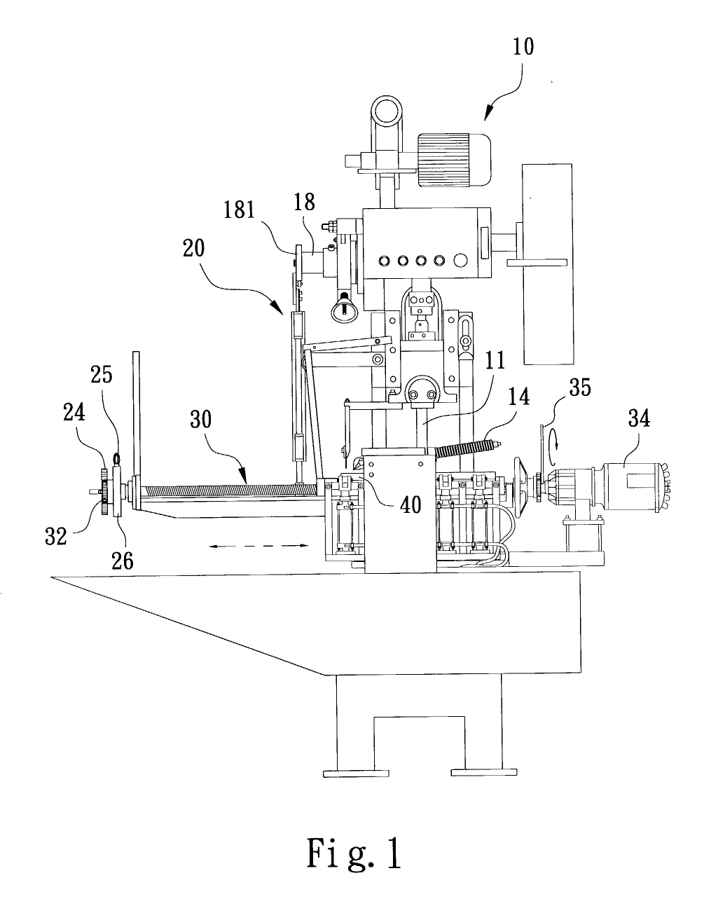

Referring to FIG. 1, taking a working machine which is a punch press 10 as an example, it is in cooperation with a set of linkage equipment 20 and a feeding mechanism 30, wherein a follower axle 18 at the lateral side of the punch press 10 is provided with a cam 181, and is provided on the bottom thereof with a reciprocating punch 11. The punch 11 is bevel in shape, and a knife set 13 progressing in a bevel way is provided under the bevel punch 11 on which a spring 14 is provided. The end of the knife set 13 progressing in a bevel way is provided with a knife 15 of which the bottom on the front end thereof has a recess 16. The recess 16 forms a pushing edge 17 at the front edge thereof; the bevel punch 11 is provided at a suitable position on the periphery thereof with an “L” shaped fin fixing rod 12.

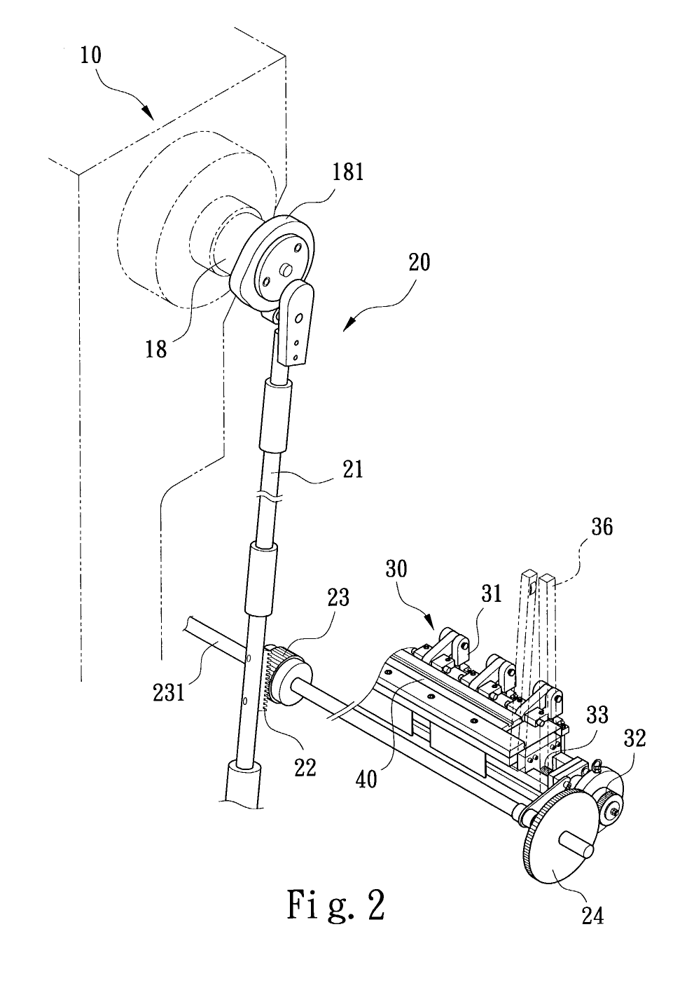

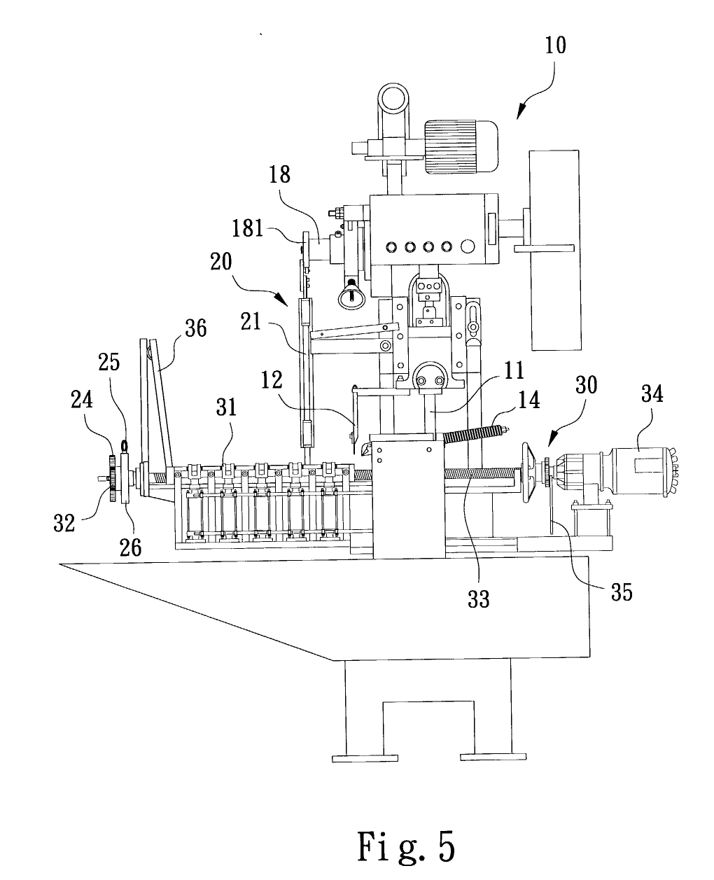

Referring to FIG. 2, the linkage equipment 20 is provided with a linked-up rod 21 which is provided on the bottom thereof with a linked-up gear rack 22, the linked-up gear rack 22 is engaged with a linked-up gear 23 which is extended through a rod 231, the rod 231 is connected on the other end thereof with a reducing gear 24. The reducing gear 24 is engaged with a transmission gear 32. The feeding mechanism is generally in a rectangular shape, and is provided on the top thereof with a clamping seat 31; the clamping seat 31 is provided for firmly clamping a material 40, and is provided on the end thereof with a contact switch 36. The clamping seat 31 is engaged with a bolt 33 internally thereof, and can be moved reciprocally on the bolt 33; one end of the bolt 33 is connected with the transmission gear 32, a dial 26 and a positioning rod 25, and the other end thereof is connected with a motor 34 which has a retroverting switch 35 (Referring FIG. 5).

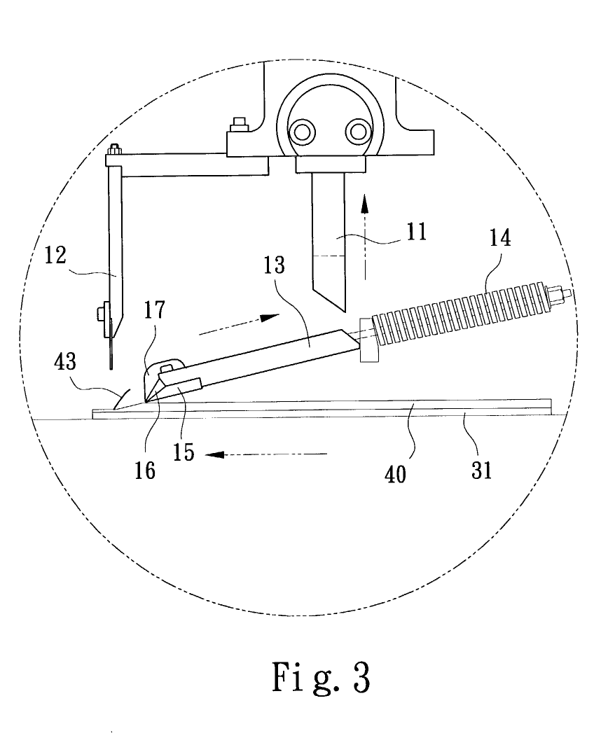

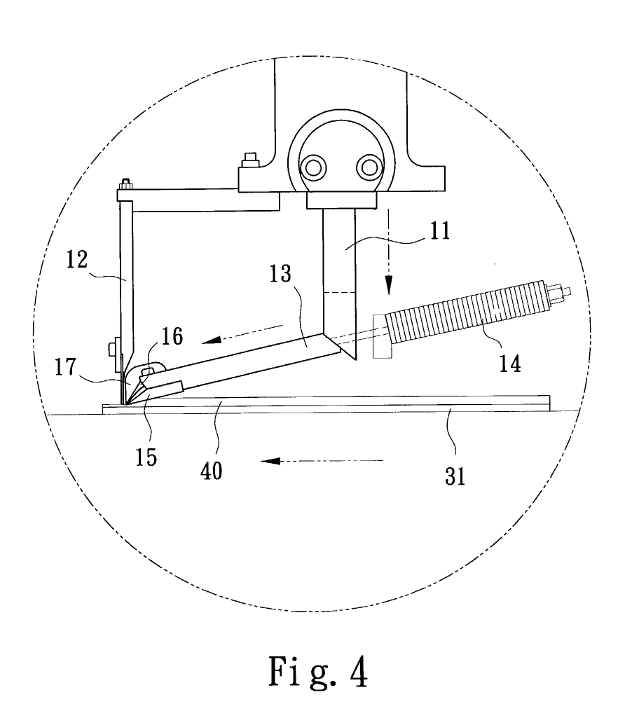

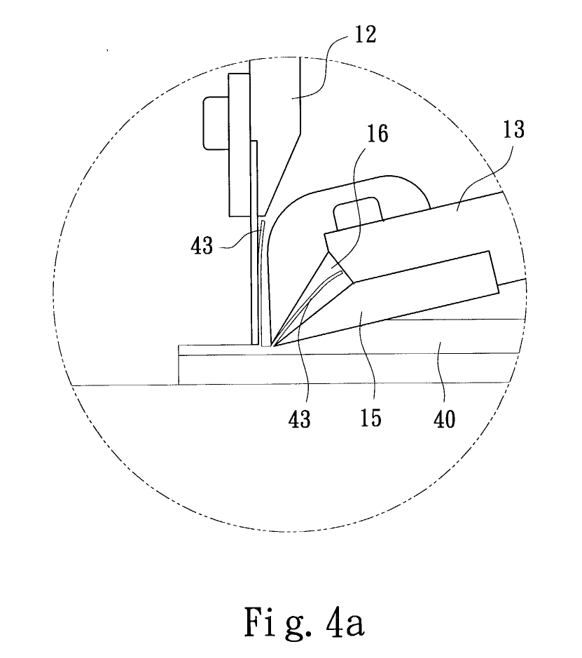

As shown in FIGS. 3-5, the a material block 40 is placed on the clamping seat 31 of the feeding mechanism 30 in the first place, and is clamped firm; then the retroverting switch 35 is activated, and the motor 34 activates the clamping seat 31 (together with the material 40) to make it slide to the starting position (namely a position under the knife 15). At this time, the punch press 10 is activated to make the punch 11 move to and fro; when the punch 11 rushes down onto the knife set 13 to push forwards the latter, the knife 15 on the front end of the knife set 13 thereby cuts the material 40 in a bevel way; when the punch 11 restores to its raised position and the force of down pressing disappears, the knife 15 restores to its original position by the spring 14 on the knife set 13. The cam 181 rotates to move the linked-up rod 21 of the linkage equipment 20 and to move the linked-up gear 23 in engagement with the linked-up gear rack 22. The linked-up gear 23 rotates the reducing gear 24 through the rod 231 when it is rotated, and also rotates the transmission gear 32 of the feeding mechanism 30. The transmission gear 32 moves the bolt 33 when it is rotated, and the bolt 33 moves forwards the clamping seat 31 to a fixed position to be fixed by the positioning rod 25. When the punch 11 of the punch press 10 once more rushes down, the knife 15 once more cuts the material 40 in a bevel way, while the fin 43 cut last time is pushed to fold up by the pushing edge 17 of the knife 15 toward the fin fixing rod 12. The process is repeatedly progressed till the entire material block 40 is completely cut into fins 43 by the knife 15. The fins 43 are abutted and positioned by the fin fixing rod 12 and the pushing edge 17 on the knife 15. And the contact switch 36 provided on the end of the clamping seat 31 is contacted to stop the operation of the machine.

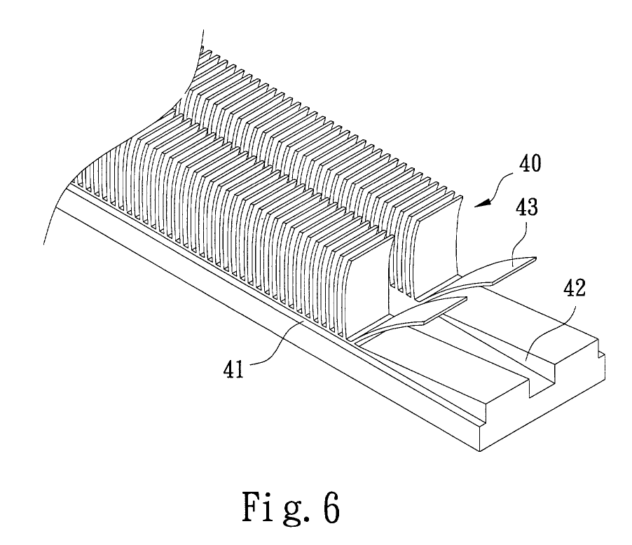

In operation, when the cam 181 rotates for 0-90°, the linkage equipment 20 moves forwards the clamping seat 31 of the feeding mechanism 30 to make it be fixed by the positioning rod 25, the punch 11 is lowered. When the cam 181 rotates for 90-180°, the linked-up rod 20 is not moved, the punch 11 contacts the knife set 13 progressing in a bevel way, and the knife 15 of the knife set 13 starts to cut in a bevel way. When the cam 181 rotates for 180-270°, the linked-up rod 20 is not moved, the punch 11 is retracted, and the knife 15 of the knife set 13 is retracted too. When the cam 181 rotates for 270-360°, the positioning rod 25 is removed from the dial 26, the linked-up rod 21 is moved back to its original position, so that the punch 11 totally gets rid of the knife set 13 progressing in a bevel way and restores to its original position. In this way, the entire process including material feeding, cutting, abutting to erect fins and knife retracting can be completed within a stroke. The material block 40 is provided on the lateral sides thereof with flanges 41 for convenience of clamping of the clamping seat 31 and is provided centrally thereof with a separating groove 42. The material block 40 in completion of cutting and folding will be in the state as shown in FIG. 6, a lot of fins 43 capable of increasing the surface area thereof can be formed thereon. Therefore, after completion of cutting and folding, the material block 40 as a whole forms a heat sink, and can be completely cut and folded in pursuance of the volume and length required, an integral heat sink with multiple and concentrated thin fins having increased surface area for heat sinking can thus be completed.

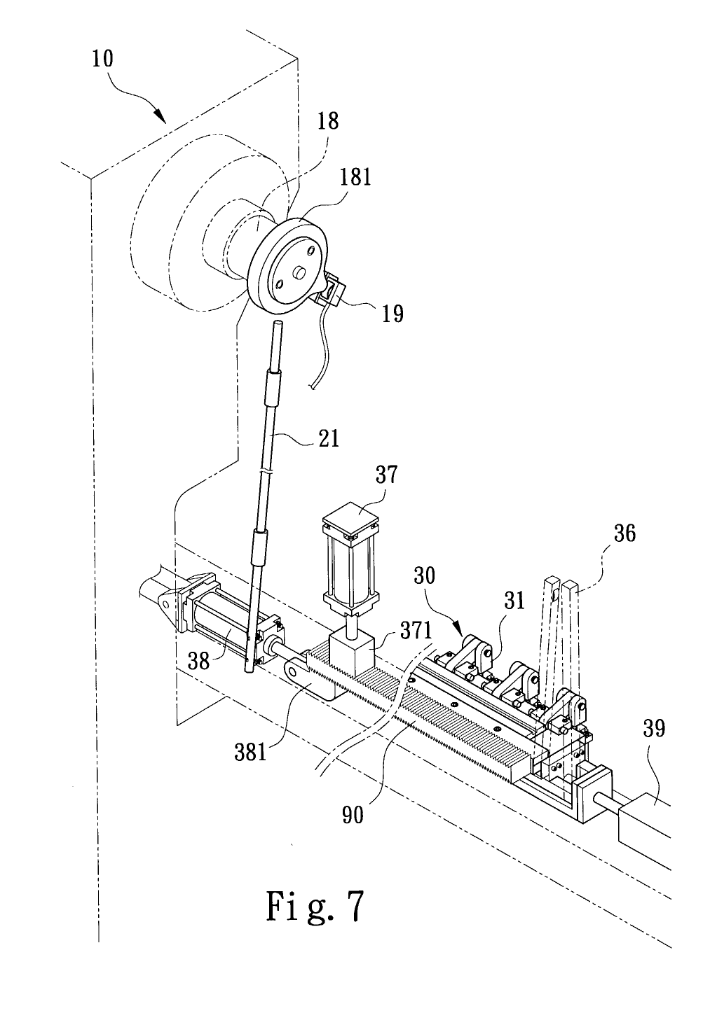

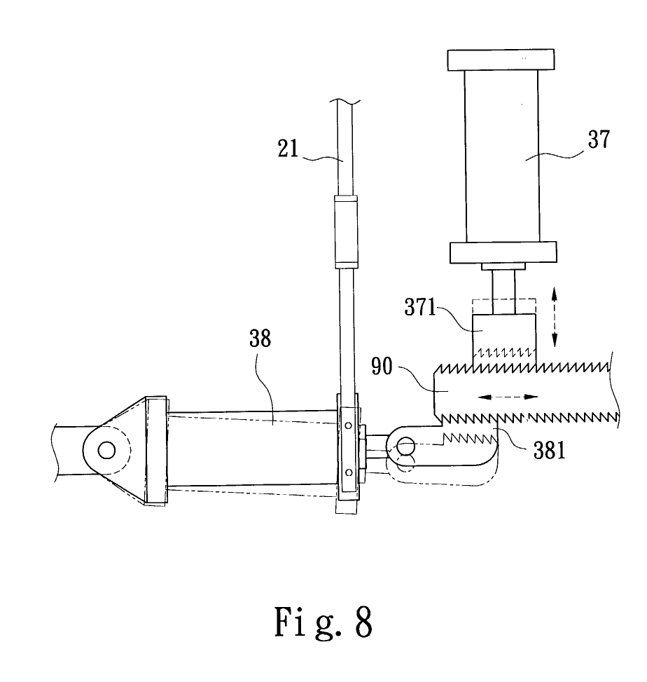

Referring FIGS. 7, 8 showing another embodiment of the present invention, wherein the bolt 33 of the feeding mechanism 30 is substituted by a gear rack 90, an air pressure cylinder “A” 37, an air pressure cylinder “B” 38 and an air pressure cylinder “C” 39 are provided to make movement of the clamping seat 31 on the gear rack 90; and wherein the cam 181 is slightly modified to contact a microswitch 19 when in rotation to thereby control the air pressure cylinder “A” 37 and the air pressure cylinder “B” 38. The air pressure cylinder “B” 38 is allocated in a longitudinal direction relative to the gear rack 90, the rear portion of its cylinder body is pivotally connected to the working machine, while the front portion of the cylinder body is provided with the linked-up rod 21. The upper end of the linked-up rod 21 is similarly moved by the cam 181, and the axle of the air pressure cylinder “B” 38 is provided on the front end thereof with a toothed pushing block 381 able to be engaged for pushing a predetermined distance each time. The air pressure cylinder “A” 37 and the gear rack 90 are allocated in a vertical direction, the front end of the cylinder axle of the air pressure cylinder “A” 37 is connected with a toothed fixing block 371.

When the cam 181 rotates for 0-270° and contacts the microswitch 19, the microswitch 19 is electrically turned on; at this time, the air pressure cylinder “A” 37 and the air pressure cylinder “B” 38 act simultaneously to move forwards and make positioning of the clamping seat 31. When the cam 181 rotates for 270-360°, the microswitch 19 is electrically turned off; the linked-up rod 21 pushes away the air pressure cylinder “B” 38, the air pressure cylinder “A” 37 and the air pressure cylinder “B” 38 are retracted to their original positions, and the material block 40 is cut in a bevel way to obtain a fin 43 by the knife 15. The process is repeatedly progressed till the contact switch 36 is contacted to stop the operation of the machine. When a new material block 40 is placed on the clamping seat 31 which gets back to its proper position by the action of the air pressure cylinder “C” 39.

The heat sink manufacturing apparatus of the present invention is advantageous in that:

1. A heat sink with an increased surface area for heat sinking can be made just by using a punch press in cooperating with a knife set progressing in a bevel way and a feeding mechanism, each set of equipment for production only costs 800 thousands New Taiwan Dollar; this saves the large cost for purchasing producing machines of high unit price, thereby, an effect of largely lowering the cost of production can be obtained.

2. The heat sink manufacturing apparatus of the present invention can reduce the space between every two fins, and can increase the area of the heat sink within a predetermined distance; thereby, the defect of inability of reducing the volume of a heat sink produced by extruding of aluminum can be effectively eliminated.

3. Using a conventional punch press of lower cost in cooperating with a knife set progressing in a bevel way and a feeding mechanism can complete the sequential actions of material feeding, rushing down, cutting in a bevel way, abutting and knife retracting within a single stroke, it is about 1.2 folds faster than the production with an expensive CNC, thereby can increase the speed of production of the heat sink in a more economic and effective way.

In conclusion, the heat sink manufacturing apparatus of the present invention can make an integral heat sink easily by using a working machine in cooperating with a knife set progressing in a bevel way and a feeding mechanism, the entire style of space of the heat sink is brand-new in comparison with conventional heat sink manufacturing apparatuses, and has evident improvement in effect.

The above stated is only a preferred embodiment of the present invention, and not for giving any limitation to the scope of the present invention. It will be apparent to those skilled in this art that various modifications or changes can be made to the elements of the present invention without departing from the spirit, scope and characteristic of this invention and shall fall within the scope of the appended claims and are intended to form part of this invention.

1. A heat sink processing apparatus comprising:
a working machine provided with a power arm to drive an elastically extending and contracting knife set progressing in a bevel way, and provided with a follower axle;
a set of linkage equipment provided with a linked-up rod of which one end is connected with a cam on said follower axle, said cam is used to move said linkage equipment, the other end of said linked-up rod is provided with a linked-up gear rack, said linked-up gear rack is engaged with a gear which is extended through a rod, said rod is connected on the other end thereof with a reducing gear;
and a feeding mechanism provided thereon with a clamping seat, said clamping seat is engaged with an internal bolt, said bolt is provided on one end thereof with a transmission gear engaged with said reducing gear of said linkage equipment, and is provided on the other end thereof with a motor.

2. A heat sink processing apparatus comprising:
a working machine provided with a power arm to drive an elastically extending and contracting knife set progressing in a bevel way, and provided with a follower axle;
a set of linkage equipment provided with a cam to contact a microswitch when in rotation to thereby control two air pressure cylinders, wherein the axle of one of said air pressure cylinders is provided on an end thereof with a toothed pushing block, the axle of the other of said air pressure cylinders is provided on an end thereof with a toothed fixing block;
and a feeding mechanism provided thereon with a clamping seat, said clamping seat is provided thereon with a gear rack, said gear rack is engaged with said toothed pushing block and said toothed fixing block on said axle of said two air pressure cylinders of said linkage equipment, and said clamping seat is provided thereunder with another air pressure cylinder.

3. The heat sink processing apparatus as in claim 1, wherein
said bolt of said feeding mechanism provided with said transmission gear is also provided with a dial and a positioning rod.

4. The heat sink processing apparatus as in claim 1, wherein
said power arm synchronically moves an “L” shaped fin fixing rod.

5. The heat sink processing apparatus as in claim 2, wherein
said power arm synchronically moves an “L” shaped fin fixing rod.

6. The heat sink processing apparatus as in claim 1, wherein
said knife set progressing in a bevel way is provided with on the front end thereof with a knife in a rectangular shape, of which the front end thereof has a recess, said recess forms a pushing edge at the front edge thereof.

7. The heat sink processing apparatus as in claim 2, wherein
said knife set progressing in a bevel way is provided with on the front end thereof with a knife in a rectangular shape, of which the front end thereof has a recess, said recess forms a pushing edge at the front edge thereof.

8. The heat sink processing apparatus as in claim 1, wherein
said clamping seat of said feeding mechanism is provided on an end thereof with a contact switch.

9. The heat sink processing apparatus as in claim 2, wherein
said clamping seat of said feeding mechanism is provided on an end thereof with a contact switch.

10. The heat sink processing apparatus as in claim 1, wherein
said motor of said feeding mechanism has a retroverting switch to make said clamping seat slide to a position under said knife.

11. The heat sink processing apparatus as in claim 2, wherein
the rear portion of the cylinder body of said air pressure cylinder with said toothed pushing block in said feeding mechanism is pivotally connected to said working machine, while the front portion of said cylinder body is provided with a linked-up rod, the upper end of said linked-up rod is moved by said cam.

12. The heat sink processing apparatus as in claim 1, wherein
said working machine is a punching press.

13. The heat sink processing apparatus as in claim 2, wherein
said working machine is a punching press.

14. The heat sink processing apparatus as in claim 1, wherein
said working machine is a CNC processing apparatus.

15. The heat sink processing apparatus as in claim 2, wherein
said working machine is a CNC processing apparatus.
